(19) United States
(12) Patent Application Publication
(10) Pub. No.: US 2008/0165278 A1
(43) Pub. Date: Jul. 10, 2008

(54) Human visual system based motion detection/estimation for video deinterlacing

(75) Inventor: Ximin Zhang, San Jose, CA (US)

Correspondence Address: HAVERSTOCK & OWENS LLP, 162 N WOLFE ROAD, SUNNYVALE, CA, 94086, US

(73) Assignees: Sony Corporation; Sony Electronics Inc.

(21) Appl. No.: 11/649,401

(22) Filed: Jan. 4, 2007

(51) Int. Cl. H04N 7/01; H04N 11/02

(52) U.S. Cl. 348/452; 375/240.01; 348/E07.003; 375/E07.076

(57) ABSTRACT

A method of effectively de-interlacing a sequence of interlace-scanned pictures receives the sequence of pictures, forms a received sequence, and performs motion detection upon the received sequence. The method generates a first threshold for measuring the accuracy of the motion detection, and measures the accuracy of the motion detection, thereby forming a first accuracy measurement. The accuracy of the motion detection is measured by using a difference calculation. The method de-interlaces a picture in the received sequence by using the first accuracy measurement. The de-interlacing is motion adaptive.

### FIELD OF THE INVENTION

The present invention relates generally to the field of moving pictures, and more particularly, to human visual system based motion detection/estimation for video de-interlacing.

### BACKGROUND

Interlaced video is designed to be captured, transmitted, stored and/or displayed in an interlaced format. Interlaced video is usually composed of two fields that are captured at different moments in time. Hence, interlaced video frames will exhibit motion artifacts when both fields are combined and displayed. However, many types of video displays, such as liquid crystal displays and plasma displays are designed as progressive scan monitors. Progressive or non-interlaced scan is considered the opposite of interlaced scan, as progressive scan devices are designed to illuminate every horizontal line of video with each frame. If these progressive scan monitors display interlaced video, the resulting display can suffer from reduced horizontal resolution and/or motion artifacts. These artifacts may also be visible when interlaced video is displayed at a slower speed than it was captured, such as when video is shown in slow motion.

Most modern computer video displays are progressive scan systems, thus interlaced video will have visible artifacts when it is displayed on computer systems. Interlacing introduces another problem called interline twitter. Interline twitter is an aliasing effect that appears under certain circumstances, such as when the subject being shot contains vertical detail that approaches the horizontal resolution of the video format. For instance, a person on television wearing a shirt with fine dark and light stripes may appear on a video monitor as if the stripes on the shirt are “twittering”.

Despite the problems with interlaced video and calls to abandon it, interlacing continues to be supported by the television standard setting organizations, and is still being included in new digital video transmission formats, such as DV, DVB (including its HD modifications), and ATSC.

To minimize the artifacts caused by interlaced video display on a progressive scan monitor, a process called deinterlacing is utilized. Deinterlacing is the process of converting an interlaced sequence of video fields into a non-interlaced sequence of frames. Conventional deinterlacing generally results in a lower resolution, particularly in areas with objects in motion. The undesirable image degradation is typically a result of temporal interpolation, and/or inaccurate motion detection, estimation, and compensation. Deinterlacing systems are integrated into progressive scan television displays in order to provide the best possible picture quality for interlaced video signals.

### SUMMARY OF THE DISCLOSURE

In the present invention, human visual system based criteria are used to determine the accuracy of the motion detection and/or motion estimation. More specifically, some embodiments include a novel hybrid de-interlacing scheme that is based on the human visual system (HVS). These embodiments measure the accuracy of motion detection and/or motion estimation. Under certain conditions, a motion compensated field copy is utilized to obtain higher vertical resolution with less temporal flickering. Further, edge based intra-interpolation is utilized to obtain better reconstruction. The decision of whether to apply inter field copy or intra-interpolation is based on the human visual system and a measure of the accuracy of motion detection and/or motion estimation.

In contrast to conventional methods, embodiments of the invention discriminate the pixel and block differences according to their impact toward perceived visual quality. For instance, human visual system based criteria are preferably considered to determine the accuracy of the motion detection and/or motion estimation. With the implementation of algorithms to model the impact on human vision, better de-interlacing results are obtained especially for complex video sequences with many horizontal edges.

More specifically, a method of effectively de-interlacing a sequence of interlace-scanned pictures receives the sequence of pictures, forms a received sequence, and performs motion detection upon the received sequence. The method generates a first threshold for measuring the accuracy of the motion detection, and measures the accuracy of the motion detection, thereby forming a first accuracy measurement. The accuracy of the motion detection is measured by using a difference calculation. The method de-interlaces a picture in the received sequence by using the first accuracy measurement (of the motion detection). The de-interlacing is motion adaptive.

A system for effectively de-interlacing a sequence of interlaced pictures includes a receiver, a motion detection module, a threshold generator, a comparator module, and a de-interlacer. The receiver is for receiving the sequence of pictures, and is configured to form a received sequence. The motion detection module is configured to detect motion in the received sequence. The threshold generator is configured to generate a first threshold for measuring the accuracy of the motion detection. The comparator module is for comparing the motion in the received sequence with one or more thresholds, to measure an accuracy of the motion detection, and thereby form a first accuracy measurement. The accuracy of the motion detection is measured by using one or more differences. The de-interlacer is for de-interlacing a picture in the received sequence by using the first accuracy measurement (of the motion detection). The de-interlacing is motion adaptive.

Preferably, the difference calculation includes a maximum sub-block luminance difference and/or a maximum sub-block chrominance difference. The first threshold is based on a property of the human visual system. For instance, generating the first threshold includes combining a background luminance masking factor and a texture masking factor according to a property of the human visual system and/or the contents of one or more pictures in the received sequence. The motion detection is typically determined as either good or bad based on the accuracy.

Some embodiments generate a second threshold for measuring the accuracy of the motion detection, while some implementations include horizontal detection. For instance, in a particular embodiment, a second threshold is generated based on a horizontal edge of the received sequence. Preferably also, the second threshold is generated by using a property of the human visual system. The second (or horizontal) threshold is adjusted at various times based on the content of the pictures and/or the visual system. The horizontal threshold adjustment includes horizontal edge detection, and the horizontal threshold adjustment includes using a second threshold according to the horizontal edge detection result.

Optionally, motion estimation is performed, based upon the motion detection, and the accuracy of the motion detection and/or estimation are measured to yield an accuracy measurement. The accuracy measurement of the motion estimation is based on the first threshold. The motion estimation is determined as either good or bad based on the accuracy. The determination of whether the motion estimation is good or bad preferably includes calculating, for a sub-block, the maximum luminance difference and the maximum chrominance difference based on a motion vector. The motion adaptive de-interlacing scheme preferably selects motion compensated field copy for a good motion block.

The determination whether the motion estimation is good or bad includes a good determination if both of the differences are less than the first threshold. The good or bad motion determination further includes a bad determination if one of a luminance difference and/or a chrominance difference is greater than a second threshold. In some of these cases, the motion adaptive de-interlacing scheme includes selecting edge oriented interpolation for a bad motion block.

### BRIEF DESCRIPTION OF THE DRAWINGS

The novel features of the invention are set forth in the appended claims. However, for purpose of explanation, several embodiments of the invention are set forth in the following figures.

FIG. 1 illustrates de-interlacing of interlaced video.

FIG. 2 illustrates one example of bad intra interpolation reconstruction.

FIG. 3 illustrates a system for measuring the accuracy of motion detection and/or motion estimation in accordance with some embodiments.

FIG. 4 illustrates a system for motion adaptive de-interlacing in accordance with embodiments of the invention.

FIG. 5 is a process flow that is relevant to FIGS. 3 and 4.

### DETAILED DESCRIPTION

In the following description, numerous details and alternatives are set forth for purpose of explanation. However, one of ordinary skill in the art will realize that the invention can be practiced without the use of these specific details. In other instances, well-known structures and devices are shown in block diagram form in order not to obscure the description of the invention with unnecessary detail.

As mentioned above, interlaced scanning is applied in current television systems. Conventionally, interlaced scanning has provided a good trade off between temporal resolution and [spatial] resolution when a physical device is a bottleneck. However, the interlaced video suffers from many visual artifacts such as edge flickering and line crawling. In order to alleviate these undesirable artifacts, de-interlacing is used to reconstruct the missing lines of each field, increase the vertical resolution, and reduce the number or severity of artifacts. With the development of high definition television (HDTV) and other display systems, progressive scan format is often preferred, rather than interlaced video. Hence, effective de-interlacing techniques are required to transfer the interlaced scanned video contents to progressive format for these modern displays.

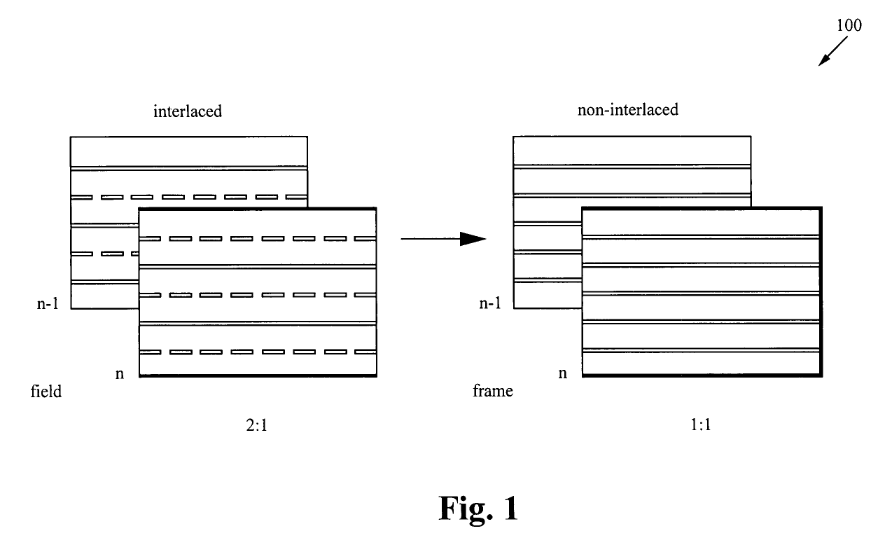

FIG. 1 illustrates de-interlacing of interlaced video. As shown in this figure, multiple fields are combined or interlaced into interlaced fields n and n−1. Hence, multiple fields are needed to produce a single frame, such as at a ratio of 2:1. While this improves frame rate and reduces transmission bandwidth requirements, deinterlacing creates a series of horizontal edges, and further includes the problem of artifacts and/or blurring within a frame, as described above.

De-interlacing has been extensively investigated for many years, which has led to the development of different types of de-interlacing. Due to its good balance between quality and low complexity, motion adaptive types of de-interlacing are widely used. For motion adaptive de-interlacing, the accuracy of motion detection and estimation is necessary for good performance. Errors from inaccurate motion detection and/or estimation cause flickering and severely degrade the quality of the resulting images. The human visual system (HVS) is particularly sensitive to some motion picture artifacts, while it is less sensitive to other artifacts.

Existing motion detection methods often focus on the accuracy of motion vectors and absolute pixel differences to decide whether there is motion. See, for example, Demin Wang, et al., Hybrid de-interlacing algorithm based on motion vector reliability, IEEE Transactions on Circuits and Systems for Video Technology, p. 1019-25, v. 15 #8, August 2005; Chang Yu-Lin, et al., Video De-interlacing by Adaptive 4-Field Global/Local, IEEE Transactions on Circuits and Systems for Video Technology, p. 1, v. PP #99, 2005; De Haan, et al., Deinterlacing-an overview, Proceedings of the IEEE, p. 1839-1857, v. 86 #9, September 1998; P. Delogne, et al., Improved interpolation, motion estimation, and compensation for interlaced pictures, IEEE Transactions on Image Processing, p. 482-91, v. 3 #5, September 1994. Each of these articles are incorporated herein by reference.

Some embodiments of the invention present a novel hybrid de-interlacing scheme that is based on the human visual system measure of motion detection and/or motion estimation. A motion compensated field copy is utilized to obtain higher vertical resolution with less temporal flickering. An edge based intra-interpolation is utilized to obtain better reconstruction. The decision of whether to employ inter field copy or intra-interpolation is based on the human visual system's ability to discriminate the pixel and block differences according to their impact on perceived visual quality. Criteria based on the human visual system are incorporated in determining the accuracy of motion detection and/or motion estimation. Some embodiments implement algorithms that model human vision that improve de-interlacing results, especially for complex video sequences that have many horizontal edges.

Section I below discusses the human visual system analysis for spatial visual distortion and temporal visual distortion. Section II describes the human visual system measure for motion detection and/or estimation. Section III discloses a de-interlacing scheme based on the human visual system, in accordance with implementations of the invention.

### I. Human Visual System Analysis for De-Interlacing

For video processing applications, an appropriate quality evaluation is the human visual system, and the goal of de-interlacing is to achieve the highest perceptual quality with an acceptable level of complexity. Human vision can not identify changes below the “just noticeable distortion” (JND) threshold, due to the underlying spatial and/or temporal sensitivities of the components of the visual system and/or the masking properties of the perceived subject matter. Typically, the just noticeable distortion level is around the level of a pixel.

Conventional research surrounding “just noticeable distortion” has been mainly focused on how to build an effective visual quality measure. Applications that exploit just noticeable distortion levels mainly include video compression and pre and/or post processing. In the following description, a procedure for the calculation of spatial JND is discussed. Then, flickering artifacts caused by de-interlacing are analyzed.

A. Spatial Just Noticeable Distortion Derivation

Pixel differences between the original and the reconstructed images are typically the source of visual distortion that can be perceived by the human visual system. For motion adaptive deinterlacing, the amount of prediction error for a block is often measured using the mean squared error (MSE) or sum-of-absolute-differences (SAD) between the predicted and actual pixel values over all pixels of a motion compensated region. The sum of absolute differences is usually used for measuring the motion estimation accuracy. The problem of the above approach is that it does not take into account the human visual system's characteristics and/or the signal contents.

Separately, many methods have been proposed for measuring the just noticeable distortion level(s) for the visual system. Two factors have been universally adapted by these methods, the background luminance masking effect and the texture masking effect. The background luminance masking effect reflects the fact that human eyes can observe less distortion in either very dark or very bright regions. The texture masking effect reflects the fact that human eyes are less sensitive to the changes in the textured regions of a picture or frame, than in the smooth areas.

In conventional de-interlacing, a single, simple, and/or ineffective criterion is predominately used for measuring the motion detection and/or estimation accuracy. Accordingly, for the human visual system, a good motion estimation result without noticeable distortion in one area may be a bad motion estimation result with obvious distortion in other areas of the video image. Thus, measuring the effectiveness of an adaptive motion detection and/or estimation result in relation to the human visual system, is desirable, and is further described below.

B. Flicker Artifacts Analysis Near Horizontal Edge

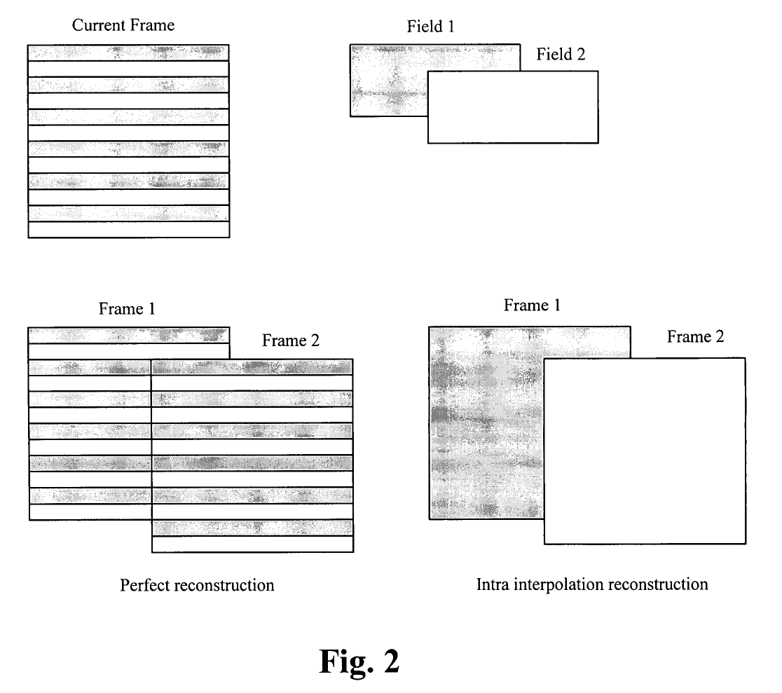

Edge oriented intra interpolation is effective to generate a higher resolution image from a lower resolution image. However, edge oriented intra interpolation may cause severe flickering artifacts when de-interlacing the interlaced video sequences. This property is illustrated in FIG. 2. FIG. 2 illustrates perfect reconstruction versus intra interpolation reconstruction. As shown in this figure, a frame is interlaced with grey lines and lines of another color such as white, in this example. Accordingly, the first field 1 is all grey, and the second field 2 is all white. If intra-interpolation is applied to each field to reconstruct the missing lines, the first reconstructed frame 1 becomes all grey and the second reconstructed frame 2 becomes all white.

Each individual frame still appears as a good quality image even though vertical resolution is lost. However, when the reconstructed sequences are displayed, the large difference in contrast, hue, color, luminosity, and other attributes, between the two reconstructed frames causes severe flickering effects, which are noticeable and/or annoying to the human eye. One of ordinary skill will recognize that the two different fields and/or frames typically contain a variety of color and/or picture contrast combinations, and that the figure is only exemplary in illustration. Nonetheless, even a single line flickering is very annoying to the human eye between frames.

Some embodiments alleviate the line flicker issue discussed above by selectively employing a simple field line copy. In some cases, field line copy advantageously achieves much better visual quality than intra interpolation, even if the motion prediction residue is relatively large. These embodiments take advantage of the human visual system's ability to tolerate more intra distortion and less temporal flickering around a horizontal edge. Hence, the areas near a horizontal edge are carefully taken into consideration by these embodiments.

### II. Human Visual System Based Motion Detection and Estimation Measure

Conventional de-interlacing uses traditional single pixel difference based motion detection or block sum-of-absolute-differences (SAD) based motion detection. According to the analysis in Section I above, these forms of motion detection are not effective and undesirably cause artifacts perceived by the visual system. In particular, the areas near a horizontal edge need a different criterion for motion detection due to the characteristics of interlaced video. Accordingly, some embodiments perform motion detection and/or motion estimation, and measure the accuracy thereof, based on properties of the human visual system.

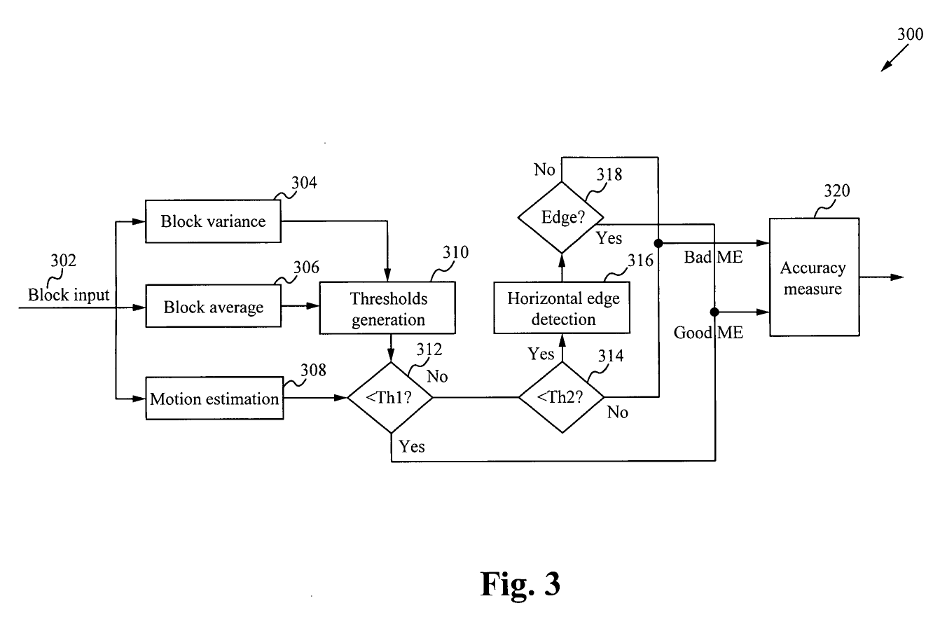

FIG. 3 illustrates the system 300 of some of these embodiments. As shown in this figure, at the beginning of processing, the current field is divided into blocks. Some embodiments use an 8 pixel×8 pixel block size, however, one of ordinary skill recognizes additional suitable block sizes. For each block, a luminance variance V(x,y) and an average A(x,y) are calculated. Preferably, the background luminance masking factor LA(x,y) is given by:

LA(x,y)=t+10[80−A(x,y)]/80, when A(x,y)<=80;

=t+10[A(x,y)−120]/135, when A(x,y)>=120;

=t, otherwise,

where t is a constant coefficient.

The just noticeable distortion value JND(x,y) is then determined by:

JND(x,y)=LA(x,y)+k[V(x,y)/LA(x,y)],

where k is a constant coefficient.

After the just noticeable distortion is obtained, thresholds Th1 and Th2 for luminance are calculated by:

Th1(x,y)=m·JND(x,y);

Th2(x,y)=n·JND(x,y),

where m and n are constant coefficients, and n>m.

Typically, thresholds for chrominance are also selected. The thresholds for chrominance are typically one fourth (¼) the thresholds for luminance.

In FIG. 3, the block input 302 is used to calculate a block variance 304 and a block average 306, which are used as the input for a threshold generator 310. Advantageously, at about the same time that the just noticeable distortion is calculated, the motion detection and/or estimation 308 are performed, and the motion compensation difference of the current block is calculated. In one embodiment, the difference is calculated line by line. In this embodiment, a maximum luminance line difference, and a maximum chrominance line difference, are calculated and stored. These maximum line differences are then compared to the threshold Th1 for both luminance and chrominance. Some implementations use a comparator module 312 for the comparison.

If both the line differences for luminance and chrominance are less than their respective thresholds, then either a static area or a good (or near perfect) motion estimation is detected. In this case, the system 300 preferably employs a motion compensated field copy at an output module 320.

If the line differences for either luminance or chrominance are greater than their respective thresholds Th1, then the line differences are compared to the respective thresholds for Th2. Some embodiments use a comparator module 314 for this comparison. If the line differences for either luminance or chrominance are greater than their respective thresholds for Th2, then no good block match can be found. That information is typically stored and/or used by the output module 320.

If the line differences for both luminance and chrominance are both less than the respective thresholds for Th2, then horizontal edge detection is applied. Here, some embodiments use an edge detector 316, which includes a number of conventional edge detection means. If there is a horizontal edge in the current block, the current motion detection and/or estimation result is determined to be good. Or, if there is no edge, then the result is determined to be bad. Regardless of the determination of the quality of the motion estimation, some embodiments store and/or use the determination in the output module 320.

One of ordinary skill recognizes that the above comparisons are also advantageously used to compare the block SAD or sub-block SAD to the thresholds. In these embodiments, the constant coefficients m and n are typically adjusted accordingly.

### III. Motion Adaptive De-Interlacing Scheme Based on the Human Visual System

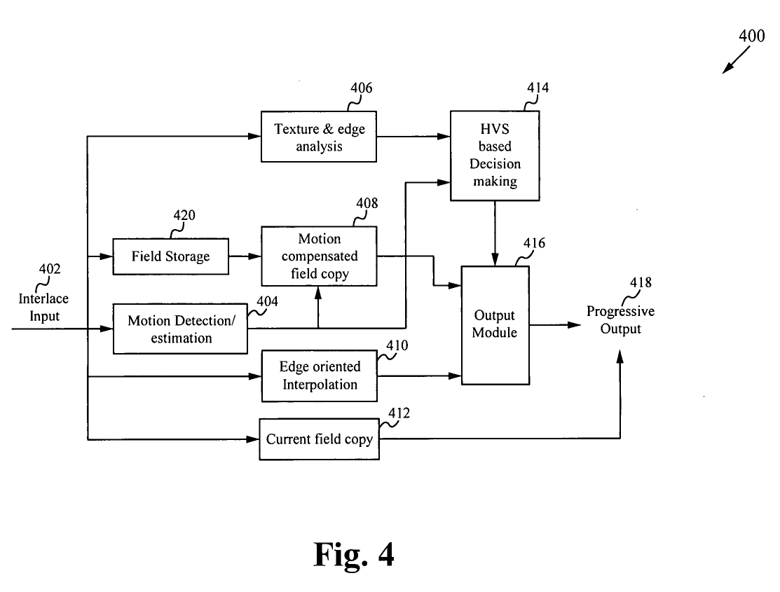

Some embodiments further include a de-interlacing scheme that employs the result(s) and/or measurements described above in relation to FIG. 3, including the result of the motion detection and/or estimation. For instance, FIG. 4 illustrates a de-interlacing system 400 that receives an interlaced input 402. For each interlaced input 402, the system 400 divides the input 402 into a top field and a bottom field and stores the fields in a field storage 420. The first line in the top field is conventionally designated as an odd line. For the reasons mentioned above, progressive scan format is the preferred output 418, and to reconstruct a first progressive frame, all the odd lines are directly copied from the top field.

Then, motion detection and/or motion estimation is performed and applied to each block in the current interlaced frame. Preferably, the motion detection and/or estimation is performed by using the motion detector/estimator module 404. At about the same time as the field storage and/or motion detection, a human visual system based texture and edge analysis is performed to obtain thresholds. Some embodiments employ the procedure described above in relation to FIG. 3, in which, at least two thresholds are determined based on properties of the human visual system. Texture and/or edge analysis is preferably conducted by a texture and edge analyzer module 406.

A decision maker 414 preferably receives the output of the texture and edge analyzer 406, and the output of the motion detector and/or estimator 404. The decision maker 414 advantageously bases its decision process on properties of the human visual system, and outputs to an output module 416. The output module 416 further receives the output of a motion compensated field copier 408, and an edge oriented interpolator 410.

If good motion detection and/or estimation are determined by the system 400, then motion compensated field copy is selected to reconstruct the even lines in the current block. Or, if good motion detection and/or estimation are not available, then edge oriented intra interpolation is selected to reconstruct the even lines in the current block. Motion compensated field copy is preferably performed by the motion compensated field copier 408, while edge oriented interpolation is performed by the edge oriented interpolator 410.

To reconstruct a second progressive frame, all the even lines are directly copied from the bottom field. This field copy is advantageously performed by a separate module 412. After the even lines are copied, the odd lines are reconstructed in the current block, by using the steps described above in relation to the first progressive frame. Alternatively, to reduce complexity, the motion detection and/or estimation result for the top field is directly applied to the bottom field. In these embodiments, the de-interlacing complexity is significantly reduced for the second field.

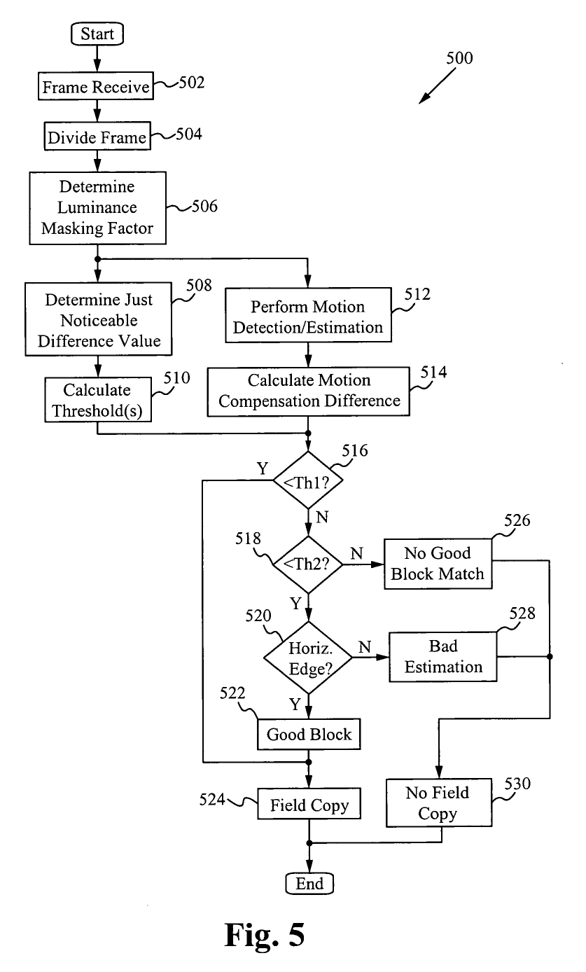

FIG. 5 illustrates a process 500 for de-interlacing interlaced video. The process 500 employs one or more result(s) from the system 300 and related algorithm for measuring the accuracy of motion determination and/or estimation of FIG. 3, and is relevant to the de-interlacer 400 of FIG. 4. As shown in FIG. 5, the process 500 begins at the step 502, where the process 502 receives a frame of interlaced data. Then, at the step 504, the process 500 divides the frame. Preferably, the frame is divided into top and bottom fields. Next, the process 500 transitions to the step 506, where a luminance masking factor is determined for at least a portion of the one or more of the divided fields. The luminance masking factor was discussed above in relation to FIG. 3.

After the luminance masking factor is determined, a just noticeable distortion (JND) value is determined at the step 508, and the process 500 transitions to the step 510, where one or more thresholds are calculated. As mentioned above, the threshold(s) are preferably calculated by the properties of the human visual system, and/or the content of the received field. Also discussed above, the thresholds of some embodiments preferably include one or more luminance value(s) and/or chrominance value(s).

Simultaneously with the steps 508 and 510, or at another suitable time, the process 500 performs motion detection and/or estimation at the step 512, and therewith calculates one or more motion compensation differences at the step 514. As described above, the quality of the motion detection and/or estimation is considered in relation to the abilities of the human visual system. For instance, the differences of some embodiments include a maximum luminance difference and/or a maximum chrominance difference, for the blocks or sub-blocks of a line. Some implementations calculate and/or store the differences line-by-line. Then, at the step 516 the differences calculated at the step 514 are compared with a first threshold determined at the step 510.

If at the step 516, the calculated differences are less than the first threshold, then the process 500 transitions to the step 524, where a motion compensated field copy is preferably selected. After the step 524, the process 500 concludes.

If at the step 516, the calculated differences are not less (are greater than) the first threshold, then the calculated differences are compared to a second threshold, at the step 518. If at the step 518, the calculated differences are greater than the second threshold, then it is determined that no good block match is found at the step 526, and the process 500 transitions to the step 530, where an algorithm other than field copy is selected, such as intra interpolation, for example. After the step 530, the process 500 concludes.

If at the step 518, the calculated differences are not greater (are less) than the second threshold, then horizontal edge detection is performed at the step 520. If no edge is detected at the step 520, then a bad motion detection and/or estimation is determined at the step 528, and the process transitions to the step 530, where field copy is not selected. Instead, another process or set of steps is selected at the step 530, and then after the step 530, the process 500 concludes.

If at the step 520, a horizontal edge is detected, then a good block is determined at the step 522, and the process 500 transitions to the step 524, where field copy is selected. As mentioned above, after the step 524, the process 500 concludes.

Accordingly, embodiments of the invention include a robust motion adaptive system for deinterlacing that is more sensitive to the abilities of human visual perception. For instance, the human visual system is more sensitive to variances in luminances at average intensities such as between 80 and 100, for example, than for regions of bright intensity such as luminances of 220 to 250, for example.

In view of the foregoing, some embodiments preferably include more than one threshold in the determination of motion detection and/or estimation. These multiple thresholds are tuned toward luminance and/or chrominance that has particular relevance to the visual system, and toward the regions of a picture that have specific properties, such as a particular texture and/or an edge, for example. Further, some embodiments employ edge detection, and intelligently decide which of a variety of de-interlacing techniques to apply, depending on the particular circumstances. Moreover, some embodiments consider maximums, such as line-by-line maximums, for each block, or each sub-block, in the difference calculations for an improved calculation and/or result. Additionally, these features of the embodiments discussed above, are relatively cost effective to implement, and hence provide greater quality, without greatly increasing costs in the display device employing such advantageous de-interlacing techniques.

While the invention has been described with reference to numerous specific details, one of ordinary skill in the art will recognize that the invention can be embodied in other specific forms without departing from the spirit of the invention. For instance, the particular functions of the systems illustrated in the figures, are preferably implemented in software, that is operating in a suitable environment. However, a variety of implementations are contemplated including a number of hardware devices such as processors, registers, and memory, for example. Thus, one of ordinary skill in the art will understand that the invention is not to be limited by the foregoing illustrative details, but rather is to be defined by the appended claims.

What is claimed is:

1. A method of effectively de-interlacing a sequence of interlace-scanned pictures, the method comprising:
receiving the sequence of pictures, thereby forming a received sequence;
performing motion detection upon the received sequence;
generating a first threshold for measuring the accuracy of the motion detection;
measuring the accuracy of the motion detection, thereby forming a first accuracy measurement, wherein the accuracy of the motion detection is measured by using a difference calculation; and
de-interlacing a picture in the received sequence by using the first accuracy measurement, wherein the de-interlacing is motion adaptive.

2. The method of claim 1, wherein the difference calculation comprises determining one or more of a luminance difference and a chrominance difference.

3. The method of claim 2, wherein the difference calculation comprises determining a maximized difference for a sub-block.

4. The method of claim 1, wherein the first threshold is based on a property of the human visual system.

5. The method of claim 1, wherein generating the first threshold comprises:
combining a background luminance masking factor and a texture masking factor according to one or more of:
a property of the human visual system, and
the contents of one or more pictures in the received sequence.

6. The method of claim 1, wherein the motion detection is determined as either good or bad based on the accuracy.

7. The method of claim 1, further comprising:
generating a second threshold for measuring the accuracy of the motion detection.

8. The method of claim 1, further comprising:
generating a second threshold, the second threshold based on a horizontal edge analysis of the received sequence, wherein the second threshold is generated by using a property of the human visual system; and
adjusting the second threshold.

9. The method of claim 8, wherein adjusting the second threshold includes horizontal edge detection.

10. The method of claim 8, wherein adjusting the second threshold includes using a second threshold according to the horizontal edge detection result.

11. The method of claim 1, further comprising:
performing motion estimation, the motion estimation based upon the motion detection; and
measuring the accuracy of the motion estimation, wherein the accuracy measurement of the motion estimation is based on the first threshold.

12. The method of claim 11, wherein the motion estimation is determined as either good or bad based on the accuracy.

13. The method of claim 11, wherein measuring the accuracy of the motion estimation includes:
calculating, for a sub-block, the maximum luminance difference and the maximum chrominance difference based on a motion vector.

14. The method of claim 11, wherein the motion adaptive de-interlacing scheme includes:
selecting motion compensated field copy for a good motion block.

15. The method of claim 11, wherein the determination whether the motion estimation is good or bad includes a good determination if both of the differences obtained are less than the first threshold.

16. The method of claim 11, wherein the good or bad motion determination includes a bad determination if one of a luminance difference and a chrominance difference is greater than a second threshold.

17. The method of claim 11, wherein the motion adaptive de-interlacing scheme includes selecting edge oriented interpolation for a bad motion block.

18. A system for effectively de-interlacing a sequence of interlaced pictures, the system comprising:
a receiver for receiving the sequence of pictures, and configured to form a received sequence;
a motion detection module configure to detect motion in the received sequence;
a threshold generator configured to generate a first threshold for measuring the accuracy of the motion detection;
a comparator for comparing the motion in the received sequence with one or more thresholds to measure an accuracy of the motion detection, thereby forming a first accuracy measurement, wherein the accuracy of the motion detection is measured by using a difference calculation; and
a de-interlacer for de-interlacing a picture in the received sequence by using the first accuracy measurement, wherein the de-interlacing is motion adaptive.

19. The system of claim 18, wherein the difference calculation comprises one or more of a maximum sub-block luminance difference and a maximum sub-block chrominance difference.

20. The system of claim 18, wherein the first threshold is based on a property of the human visual system.

21. The system of claim 18, wherein generating the first threshold comprises:
combining a background luminance masking factor and a texture masking factor according to one or more of:
a property of the human visual system, and
the contents of one or more pictures in the received sequence.

22. The system of claim 18, wherein the motion detection is determined as either good or bad based on the accuracy.

23. The system of claim 18, further comprising:
generating a second threshold for measuring the accuracy of the motion detection.

24. The system of claim 18, further comprising:
generating a second threshold, the second threshold based on a horizontal edge analysis of the received sequence, wherein the second threshold is generated by using a property of the human visual system; and
adjusting the second (horizontal) threshold.

25. The system of claim 24, wherein the horizontal threshold adjustment includes horizontal edge detection.

26. The system of claim 18, further comprising:
performing motion estimation, the motion estimation based upon the motion detection; and
measuring the accuracy of the motion estimation, wherein the accuracy measurement of the motion estimation is based on the first threshold.

27. The system of claim 26, wherein the motion estimation is determined as either good or bad based on the accuracy.

28. The system of claim 26, wherein the determination whether the motion estimation is good or bad includes:
calculating, for a sub-block, the maximum luminance difference and the maximum chrominance difference based on a motion vector.

29. The system of claim 26, wherein the motion adaptive de-interlacing scheme includes:
selecting motion compensated field copy for a good motion block.

30. The system of claim 26, wherein the determination whether the motion estimation is good or bad includes a good determination if both of the differences obtained are less than the first threshold.

31. The system of claim 26, wherein the good or bad motion determination includes a bad determination if any one of the differences obtained is greater than a second threshold.

32. The system of claim 31, wherein the motion adaptive de-interlacing scheme includes selecting edge oriented interpolation for a bad motion block.

33. A system for effectively encoding a sequence of pictures, the system comprising:
means for human visual system based threshold generation;
means for human visual system based horizontal threshold adjustment;
means for determining whether a motion determination is good and bad, by using a sub-block luminance difference and a sub-block chrominance difference; and
a scheme for motion adaptive de-interlacing by using a measure of accuracy for one of motion detection and motion estimation, the accuracy measure based on a property of the human visual system.

34. The system of claim 33, wherein one of the luminance difference and the chrominance difference comprises a maximum difference.

35. The system of claim 33, wherein the difference is calculated at less than the level of a macroblock.
